(19) United States
(12) Patent Application Publication
(10) Pub. No.: US 2006/0110997 A1
(43) Pub. Date: May 25, 2006

(54) Treated nonwoven fabrics and method of treating nonwoven fabrics

(76) Inventor: Hue S. Snowden, Woodstock, GA (US)

Correspondence Address: KIMBERLY-CLARK WORLDWIDE, INC., 401 NORTH LAKE STREET, NEENAH, WI, 54956, US

(21) Appl. No.: 10/996,850

(22) Filed: Nov. 24, 2004

(51) Int. Cl. B32B 27/04; B32B 5/02; B32B 27/12; C11D 3/00

(52) U.S. Cl. 442/79; 442/93; 442/110; 8/115.51

(57) ABSTRACT

The present invention provides a method of treating a nonwoven fabric to provide the fabric with repellency to fluids while minimizing impact to the hydrostatic head properties of the fabric. Generally, the process includes contacting a nonwoven fabric with an aqueous treatment solution that includes a fluoropolymer and a polymeric antistatic agent.

This application incorporates by reference U.S. patent application Ser. No. 10/723,408, titled “Method of Treating Nonwoven Fabrics with Non-Ionic Fluoropolymers”, to Hue Scott Snowden et al. filed on Nov. 25, 2003. This application claims priority from the aforementioned patent application.

### TECHNICAL FIELD

This invention relates to treated nonwoven fabrics and to methods of treating nonwoven fabrics.

### BACKGROUND OF THE INVENTION

The manufacture of nonwoven fabrics for diverse applications has become a highly developed technology. Methods of manufacturing nonwoven fabrics include spunbonding, meltblowing, carding, airlaying, and so forth. It is not always possible, however, to produce by these methods a nonwoven fabric having all desired attributes for a given application. As a result, it is often necessary to treat nonwoven fabrics by various means to impart desired properties. For example, for medical applications such as surgeon's gowns, barrier properties to alcohol and aqueous (e.g. blood penetration) and bacteria are desired, and antistatic properties are important as well. Unfortunately, treatments for barrier properties using fluorocarbons, for example, and treatments for antistatic properties using salts are detrimental to each other which makes it necessary to apply excessive amounts of one or both of the treatments. Current methods of treating nonwoven fabrics require slightly to moderately charged, either cationic or anionic, fluoropolymers suspended in water and then combined with anionic antistatic agents in a single bath treatment to produce an alcohol repellent, antistatic surgical fabric. Unfortunately, the antistatic agents currently being used are surface active in nature and negatively impact the water repellency of the finished web as measured by hydrostatic head testing. In addition, the antistatic agents tend to destabilize ionic fluoropolymer suspensions, leading to coagulation and filter plugging issues. Efforts to completely remove the antistat from the bath and apply it downstream on the body side of the web have resulted in a loss of alcohol repellency at equivalent fluoropolymer bath concentrations due to low adsorbed amounts of fluoropolymer on the fabric.

There is a need for a method of topically treating nonwoven fabrics with both alcohol repellent and antistatic chemistries that do not negatively affect the water barrier of the fabric and a need for the resulting fabrics for surgical and other applications.

### SUMMARY OF THE INVENTION

The present invention describes a method of treating a nonwoven fabric to improve the alcohol repellency of the nonwoven fabric while minimizing effect of the treatment on the water repellency of the nonwoven fabric, the method includes contacting a nonwoven fabric made from or including polyolefin fibers with an aqueous treatment solution that includes at least from about 0.1 weight percent to about 5 weight percent of a fluoropolymer and from about 0.01 to about 5 weight percent of a polymeric antistatic agent. In certain embodiments, the polymeric antistatic agent is a cationic polymeric compound or an acrylic copolymer. Polymeric antistatic agent may be selected from the group consisting of cationic polymeric compounds, acrylic copolymers and cationic acrylic copolymers. In certain desirable embodiments, the polymeric antistatic agent is a cationic polymeric compound that is soluble in water and forms a solution having a pH of greater than about 7.5. Desirably, the fluoropolymer is a non-ionic fluoropolymer. The non-ionic fluoropolymer may be a fluoroalkyl acrylate homopolymer, a fluoroalkyl acrylate copolymer, a fluorinated siloxane, a fluorinated silicone, a fluorinated urethane, or a mixture that includes any of the previously listed fluoropolymers. In certain desirable embodiments, the non-ionic fluoropolymer is a non-ionic fluoroalkyl acrylate copolymer. The nonwoven fabric may be a spunbond fabric, a meltblown fabric or a laminate that includes at least one spunbond fabric or layer or at least one meltblown fabric or layer. The present invention also provides nonwoven fabrics treated according to the methods described above and herein. Desirably, the hydrostatic head value of the treated nonwoven fabric drops by no more than about 10 percent relative to the hydrostatic head value of the untreated nonwoven fabric. The nonwoven fabric or only a portion of a nonwoven fabric may be treated.

Nonwoven fabrics that include both a fluoropolymer and a polymeric antistatic agent are described herein. The nonwoven fabrics are useful as infection control products and may be used to form all or a portion of infection control products such as surgical drapes and gowns. In certain embodiments, the nonwoven fabric has a hydrostatic head value of greater than 70 mBar as measured by Federal Test Standard 191A, Method 5514. In certain other embodiments, the treated nonwoven fabric has an alcohol repellency of at least 60 percent as measured by INDA Standard Test No. IST 80.9-74 (R-82) and a hydrostatic head value of greater than 75 mBar as measured by Federal Test Standard 191A, Method 5514 and the method of treating the nonwoven fabric decreases the hydrostatic head value of the nonwoven fabric by less than 10 percent. In still other embodiments, the treated nonwoven fabric has an alcohol repellency of at least 75 percent as measured by INDA Standard Test No. IST 80.9-74 (R-82) and a hydrostatic head value of greater than 70 mBar as measured by Federal Test Standard 191A, Method 5514. In many embodiments, the nonwoven fabric is an infection control fabric that is or includes a spunbond/meltblown/spunbond laminate, a spunbond/film/spunbond laminate, a spunbond/film/spunbond/meltblown/spunbond laminate or a spunbond/film/film/spunbond laminate.

In one desirable embodiment, the present invention provides a method of improving the alcohol repellency of a nonwoven laminate by applying a topical treatment to a nonwoven laminate while minimizing any negative effect of the topical treatment on the water repellency of the nonwoven laminate that includes: contacting an aqueous treatment solution that includes from about 0.20 weight percent to about 5 weight percent of a mixture of a fluoropolymer and a polymeric antistatic agent with the nonwoven laminate or a portion of the nonwoven laminate wherein the fluoropolymer is selected from the group consisting of non-ionic fluoroalkyl acrylate homopolymers, fluoroalkyl acrylate copolymers, fluorinated siloxanes, fluorinated silicones, fluorinated urethanes, and mixtures thereof.

### BRIEF DESCRIPTION OF THE DRAWINGS

The invention will be more fully understood and further advantages will become apparent when reference is made to various embodiments described in the following description and accompanying drawings in which:

FIG. 1 is a schematic of one treatment process embodiment of the present invention using a saturation treatment step followed by a spray treatment step.

FIG. 2 is a schematic of a second treatment process embodiment of the present invention using a foam applicator instead of a spray treatment step.

FIG. 3 is a schematic of an exemplary second step of a process of the invention using ink jet treating.

FIG. 4 is a schematic of a third treatment embodiment of the present invention in which an antistatic agent and repellent treatments are applied to opposite sides of a substrate.

Repeated use of reference characters in the present specification and drawings is intended to represent same or analogous features or elements of the present invention.

Test Procedures

Hydrostatic Head: A measure of the liquid barrier properties of a fabric is the hydrostatic head test. The hydrostatic head test determines the height of water (in centimeters) which the fabric will support before a predetermined amount of liquid passes through. A fabric with a higher hydrostatic head reading indicates it has a greater barrier to liquid penetration than a fabric with a lower hydrostatic head. The hydrostatic head test is performed according to Federal Test Standard 191A, Method 5514.

The test head of a Textest FX-300 Hydrostatic Head Tester, available from Schmid Corporation, having offices in Spartanburg, S.C. was filled with purified water. The purified water was maintained at a temperature between 65° F. and 85° F. (between about 18.3° C. and 29.4° C.), which was within the range of normal ambient conditions (about 73° F. (about 23° C.) and about 50 percent relative humidity) at which this test was conducted. An 8 inch by 8 inch (about 20.3 cm by 20. 3 cm) square sample of the test material was placed such that the test head reservoir was covered completely. The sample was subjected to a standardized water pressure, increased at a constant rate until leakage was observed on the outer surface of the sample material. Hydrostatic pressure resistance was measured at the first sign of leakage in three separate areas of the sample. This test was repeated for 10 specimens of each sample material. The hydrostatic pressure resistance results for each specimen were averaged and recorded in millibars. One millibar of hydrostatic pressure is equal to 0.98 centimeters of height in water. Again, a higher value indicates greater resistance to water penetration and is desirable for barrier applications.

Alcohol: The alcohol repellency test is designed to measure the resistance of nonwoven fabrics to penetration by low surface tension liquids, such as alcohol/water solutions. Alcohol repellency was tested according to the test procedure described as follows. In this test, a fabric's resistance to penetration by low surface energy fluids is determined by placing 0.1 ml of a specified volume percentage of isopropyl alcohol (IPA) solution in several different locations on the surface of the fabric and leaving the specimen undisturbed for 5 minutes. In this test, 0.1 ml of serially diluted isopropyl alcohol and distilled water solutions, ranging from 60 volume percent to 100 volume percent in increments of 10 percent, are placed on a fabric sample arranged on a flat surface. After 5 minutes, the surface is visually inspected and the highest concentration retained by the fabric sample is noted. For example, if the minimum value is a 70 percent IPA solution, a 70 percent IPA solution is retained by the fabric but an 80 percent solution penetrates through the fabric to the underlying surface. The grading scale ranges from 0 to 5, with 0 indicating the IPA solution wets the fabric and 5 indicating maximum repellency. Unless stated otherwise, the percent alcohol (IPA) repellency reported indicates the maximum volume percent of IPA that could be added to water while still retaining a 5 rating on the scale at all points of the fabric tested. This procedure is a modification of INDA Standard Test No. IST 80.9-74 (R-82).

Antistatic properties were measured according to INDA Standard Test 40.2-92.

Porosity results were obtained by Frazier Porosity tests, ASTM Standard D737 “Air Permeability of Textile Fabrics,” also Method 5450 Federal Test Methods Standard No. 191A, except that the specimen size is 8 inches by 8 inches.

Definitions

As used herein the terms “antistatic agen” and “antistat” refer to a reagent capable of preventing, reducing or dissipating static electrical charges that may be produced on textile materials such as nonwoven surgical gowns.

As used herein and in the claims, the term “comprising” is inclusive or open-ended and does not exclude additional unrecited elements, compositional components, or method steps.

As used herein, the term “conjugate fibers” refers to fibers which have been formed from at least two polymers extruded from separate extruders but spun together to form one fiber. Conjugate fibers are also sometimes referred to as multicomponent or bicomponent fibers. The polymers are usually different from each other though conjugate fibers may be monocomponent fibers. The polymers are arranged in substantially constantly positioned distinct zones across the cross-section of the conjugate fibers and extend continuously along the length of the conjugate fibers. The configuration of such a conjugate fiber may be, for example, a sheath/core arrangement wherein one polymer is surrounded by another or may be a side-by-side arrangement, a pie arrangement or an “islands-in-the-sea” arrangement. Conjugate fibers are taught in U.S. Pat. No. 5,108,820 to Kaneko et al., U.S. Pat. No. 4,795,668 to Krueger et al., U.S. Pat. No. 5,540,992 to Marcher et al. and U.S. Pat. No. 5,336,552 to Strack et al. Conjugate fibers are also taught in U.S. Pat. No. 5,382,400 to Pike et al. and may be used to produce crimp in the fibers by using the differential rates of expansion and contraction of the two (or more) polymers. For two component fibers, the polymers may be present in ratios of 75/25, 50/50, 25/75 or any other desired ratios. The fibers may also have shapes such as those described in U.S. Pat. No. 5,277,976 to Hogle et al., U.S. Pat. No. 5,466,410 to Hills and 5,069,970 and 5,057,368 to Largman et al., which describe fibers with unconventional shapes.

As used herein, the term “infection control product” means medically oriented items such as surgical gowns and drapes, face masks, head coverings like bouffant caps, surgical caps and hoods, footwear like shoe coverings, boot covers and slippers, wound dressings, bandages, sterilization wraps, wipers, garments like lab coats, coveralls, aprons and jackets, patient bedding, stretcher and bassinet sheets, and the like.

As used herein, the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin et al. Meltblown fibers are may be continuous or discontinuous and are generally smaller than 10 microns in average diameter. The microfibers are generally tacky when deposited onto a collecting surface.

As used herein, the term “multilayer laminate” means a laminate wherein one or more of the layers, for example, are spunbond and/or some meltblown such as a spunbond/meltblown/spunbond (SMS) laminate and others as disclosed in U.S. Pat. No. 4,041,203 to Brock et al., U.S. Pat. No. 5,169,706 to Collier, et al, U.S. Pat. No. 5,145,727 to Potts et al., U.S. Pat. No. 5,178,931 to Perkins et al. and U.S. Pat. No. 5,188,885 to Timmons et al. Such a laminate may be made by sequentially depositing onto a moving forming belt first a spunbond fabric layer, then a meltblown fabric layer and last another spunbond layer and then bonding the laminate in a manner described below. Alternatively, the fabric layers may be made individually, collected in rolls, and combined in a separate bonding step. Such fabrics usually have a basis weight of from about 0.1 to 12 osy (3 to 400 gsm), or more particularly from about 0.75 to about 3 osy. Multilayer laminates may also have various numbers of meltblown layers or multiple spunbond layers in many different configurations and may include other materials like films (F) or coform materials, e.g. SMMS, SM, SFS, and so forth.

As used herein, the term “nonwoven fabric or web” means a web having a structure of individual fibers or threads which are interlaid, but not in an identifiable manner as in a knitted fabric. Nonwoven fabrics or webs have been formed from many processes such as for example, meltblowing processes, spunbonding processes, and bonded carded web processes. The basis weight of nonwoven fabrics is usually expressed in ounces of material per square yard (osy) or grams per square meter (gsm) and the fiber diameters useful are usually expressed in microns or an equivalent but more recognized term, micrometers. (Note that to convert from osy to gsm, multiply osy by 33.91). As used herein the term “spunbonded fibers” refers to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al. Spunbond fibers are generally not tacky when they are deposited onto a collecting surface. Spunbond fibers are generally continuous and have average diameters (from a sample of at least 10) larger than 7 microns, more particularly, between about 10 and 20 microns. The fibers may also have shapes such as those described in U.S. Pat. No. 5,277,976 to Hogle et al., U.S. Pat. No. 5,466,410 to Hills and 5,069,970 and 5,057,368 to Largman et al., which describe fibers with unconventional shapes.

As used herein, the term “polymer” generally includes but is not limited to, homopolymers, copolymers, such as for example, block, graft, random and alternating copolymers, terpolymers, and so forth, and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein, “thermal point bonding” involves passing a fabric or web of fibers to be bonded between a heated calender roll and an anvil roll. The calender roll is usually, though not always, pattemed in some way so that the entire fabric is not bonded across its entire surface, and the anvil roll is usually flat. As a result, various patterns for calender rolls have been developed for functional as well as aesthetic reasons. One example of a pattern has points and is the Hansen Pennings or “H&P” pattern with about a 30 percent bond area with about 200 bonds/square inch as taught in U.S. Pat. No. 3,855,046 to Hansen and Pennings. The H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). The resulting pattern has a bonded area of about 29.5 percent. Another typical point bonding pattern is the expanded Hansen Pennings or “EHP” bond pattern which produces a 15 percent bond area with a square pin having a side dimension of 0.037 inches (0.94 mm), a pin spacing of 0.097 inches (2.464 mm) and a depth of 0.039 inches (0.991 mm). Another typical point bonding pattern designated “714” has square pin bonding areas wherein each pin has a side dimension of 0.023 inches, a spacing of 0.062 inches (1.575 mm) between pins, and a depth of bonding of 0.033 inches (0.838 mm). The resulting pattern has a bonded area of about 15 percent. Yet another common pattern is the C-Star pattern which has a bond area of about 16.9 percent. The C-Star pattern has a cross-directional bar or “corduroy” design interrupted by shooting stars. Other common patterns include a diamond pattern with repeating and slightly offset diamonds with about a 16 percent bond area and a wire weave pattern looking as the name suggests, e.g. like a window screen, with about a 19 percent bond area. Typically, the percent bonding area varies from around 10 percent to around 30 percent of the area of the fabric laminate web. As is well known in the art, the spot bonding holds the laminate layers together as well as imparts integrity to each individual layer by bonding filaments and/or fibers within each layer.

Composition percent amounts herein are expressed by weight unless otherwise indicated.

### DETAILED DESCRIPTION OF THE INVENTION

The present invention relates to treatment of nonwoven substrates to impart desired properties, particularly alcohol repellency and static decay, to the nonwoven substrates. Desirably, the present invention provides a topical treatment package for a base fabric, e.g. a nonwoven fabric that will deliver repellency to low surface tension fluids and static charge dissipation while not negatively influencing hydrostatic head or blood strikethrough of a base fabric. Suggested nonwoven substrates include, but are not limited to, nonwoven fabrics including laminates that include at least one meltblown (M) layer and/or at least one spunbond layer (S), spunbond/meltblown (SM) laminates, spunbond/meltblown/spunbond (SMS) laminates, spunbond/film/spunbond (SFS) laminates, spunbond/film/spunbond/meltblown/spunbond (SFSMS) laminates and spunbond/film/film/spunbond (SFFS) laminate and laminates and combinations thereof. The invention also relates to and includes nonwoven fabrics having, for example, one or both surfaces that are alcohol repellent and have antistatic properties. Such fabrics are suitable for use in the manufacture of infection control medical products including surgical gowns and sterilization wrap and in industrial work wear such as lab coats used in environments in which static build up is undesirable. Such nonwoven fabrics also have excellent barrier properties as measured by hydrostatic head and are useful as surgical fabrics and as components in surgical gowns, drapes, surgical packs and so forth. Advantageously, fabrics and fabric laminates of the present invention can be made at lower basis weights while maintaining acceptable barrier properties.

The present invention is described by reference to the test methods and definitions described above and to specific embodiments of the invention, one or more examples of which are set forth below. Each example is provided by way of explanation of the invention, not as a limitation of the invention. In fact, it will be apparent to those skilled in the art that various modifications and variations can be made in this invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention, which broader aspects are embodied in the exemplary constructions.

The present invention provides an improved method of topically treating nonwoven fabrics with a fluoropolymer chemistry that improves the alcohol repellency of the fabric while minimizing any negative effect on the water barrier of the fabric. In one exemplary embodiment, the method of treating nonwoven fabrics includes treating a nonwoven fabric with a solution or a suspension that includes at least one non-ionic fluoropolymer and at least one polymeric antistatic agent. The inclusion of conventional nonpolymeric antistatic agents, such as phosphate ester salts, as traditionally used negatively affected the water repellency of the fabric. Desirably, the amount of polymeric antistatic agent in the treatment solutions of the present invention is from about 0.01 weight percent to about 5 weight percent, more desirably from about 0.05 weight percent to about 5, still more desirably from about 0.05 weight percent to about 3 weight percent and still more desirably from about 0.05 weight percent to about 1 weight percent. Higher concentrations of antistatic agent are desirable in work wear applications and products for work wear applications such as coveralls. Lower concentrations of antistatic agent may be desirable in other applications such as sterilization wrap.

In addition, conventional antistatic agents have been observed to destabilize ionic fluoropolymer suspensions of charged fluoropolymers in the treatment bath solution or suspension. Destabilization of the treatment bath is undesirable and causes coagulation and filter plugging during the treatment process. The present invention solves these problems by using a polymeric antistatic agent. Generally, antistatic agents are reagents that prevent or greatly reduce electrical charges that may be produced on textile materials and are also referred to as antistats. Suggested commercial examples of polymeric antistatic agents suitable for use in the present invention include, but are not limited to, NICEPOLE® FL from NICCA USA of Fountain Inn, South Carolina and POLYMERIC ANTISTAT from Manufacturers Chemicals of Cleveland, Tennessee. NICEPOLE® FL as obtained from NICCA USA is a polymeric antistatic agent that is a cationic polymeric compound. NICEPOLE® FL is an acrylic copolymer antistatic agent that is provided in an aqueous solution with 3 to 3.5 percent isopropyl alcohol. NICEPOLE® FL antistatic agent is soluble in cold water, or at least soluble in cold water and alcohol, and has a pH of about 8. POLYMERIC ANTISTAT as obtained from Manufacturers Chemical has a pH of about 7.7 to 8.5 in a 1 percent solution of water.

In one desirable embodiment, the present invention provides a method of topically treating surgical fabric that includes treating the fabric with a solution or suspension that includes a non-ionic fluoropolymer and a polymeric antistatic agent. Non-ionic fluoropolymers include, but are not limited to, non-ionic fluoroalkyl acrylate homopolymers and copolymers, such as fluorinated siloxanes, fluorinated silicones, fluorinated urethanes and so forth. A non-ionic fluoropolymer was obtained from Daikin America, Inc. of Orangeberg, N.Y. an affiliate of Daikin Industries, Ltd of Japan under the trade designations UNIDYNE® S-1072 and UNIDYNE® TG-KC02. UNIDYNE® TG KC02 is a non-ionic fluoroalkyl acrylate copolymer emulsion that consists essentially of about 30 to 31 weight percent of a non-ionic, fluoroalkyl acrylate copolymer, about 60 to 62 weight percent of water and about 8 weight percent of tripropylene glycol. Another non-ionic fluoropolymer that is commercially available from Mitsubishi International Corporation of New York is REPEARL F-7105. REPEARL F-7105 is an emulsion of about 30 weight percent of a non-ionic fluoroacrylate copolymer, about 60 weight percent of water and about 10 weight percent of dipropylene glycol. It is suggested that the treatment solution or suspension includes at least one non-ionic fluoropolymer and at least one polymeric antistatic agent. The treatment solution may include other optional ingredients including additional fluoropolymers and/or antistatic agents. The antistatic agent is desirably a polymeric antistatic agent that is soluble in water and is preferably applied to both sides of the fabric with the fluoropolymer in a single treatment solution. However, the polymeric antistatic agent may be applied to the treated fabric after the water repellency treatment and may be applied on one or both sides of the fabric. It is believed that using a non-ionic fluoropolymer treatment rather than an ionic fluoropolymer treatment reduces electrostatic interactions in the treatment solution or suspension and improves bath stability. It is also believed that electrostatic interactions hinder adsorption of the treatment solution onto the fabric. Advantageously, treatment solutions and treatment methods of the present invention do not include or require a salt, for example a metal salt.

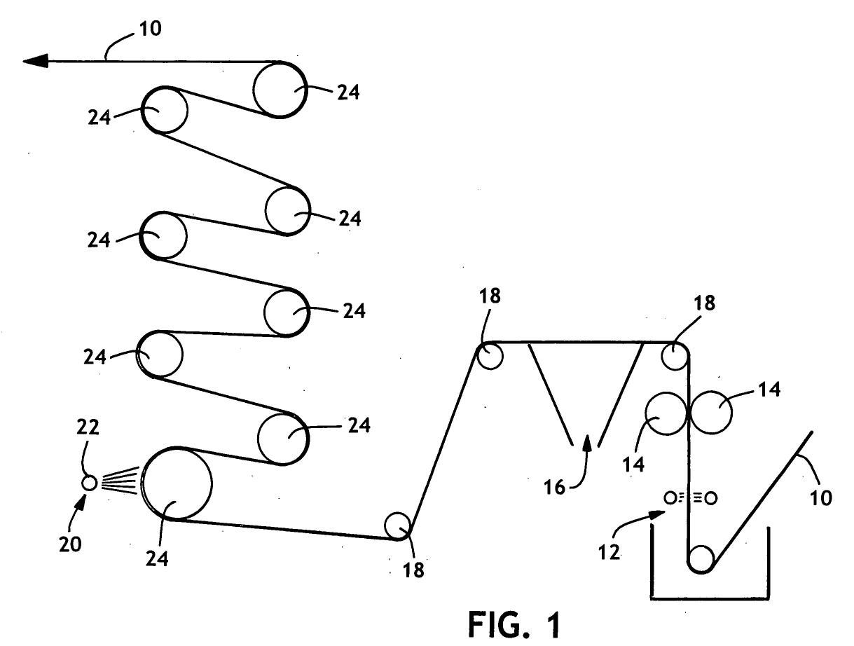

Turning to the drawings, FIG. 1 shows a web 10, for example a nonwoven fabric web, traveling from right to left. At saturation spray device 12, a solution that includes both a fluorocarbon and polymeric antistatic agent is applied, as a spray, to both sides of the fabric. Squeeze nip rolls 14 remove excess treatment solution and a vacuum extractor 16 removes additional treatment composition as web 10 travels over guide rolls 18. At treatment station 20 additional optional additives may be applied or, alternatively a fluoropolymer or a polymeric antistatic agent may applied to one or both sides of the web 10 in a separate step by spray device 22 and at a point preferably prior to full curing of the treated fabric. Generally, it is desirable to apply the antistatic treatment to both sides of the web 10 however; in some instances, it may be desirable to apply the polymeric antistatic to only one side only of web 10. Web 10 is then dried by contact with steam cans 24. In certain embodiments, it is suggested that only one side, the body-contacting side, of a nonwoven fabric that is to be used as a surgical gown or other barrier is treated with an antistat so that the antistat does not interfere with the water repellency of the exterior side of the fabric.

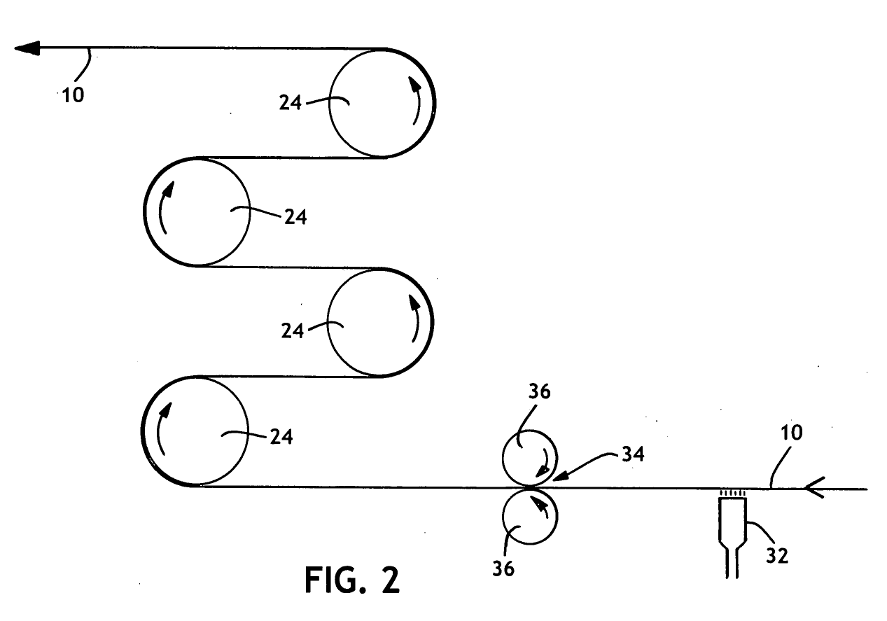

FIG. 2 shows a process using a foam applicator to apply a fluorochemical and a polymeric antistatic treatment composition instead of an antistatic spray device 22 as in FIG. 1. For FIG. 2, the system may be the same as FIG. 1 prior to the antistat spray 20 (FIG. 1) and is not shown. In FIG. 2, a single foam applicator 32 is illustrated as applying a fluorocarbon and polymeric antistatic agent containing composition as a foam to only one side of a nonwoven fabric 10. However, a second foam applicator may be provided to apply a fluorocarbon and antistatic agent composition to the other side of the fabric as well. Excess is removed in the nip 34 between squeeze rolls 36, and web 10 is directed over steam cans 24 for drying as in FIG. 1.

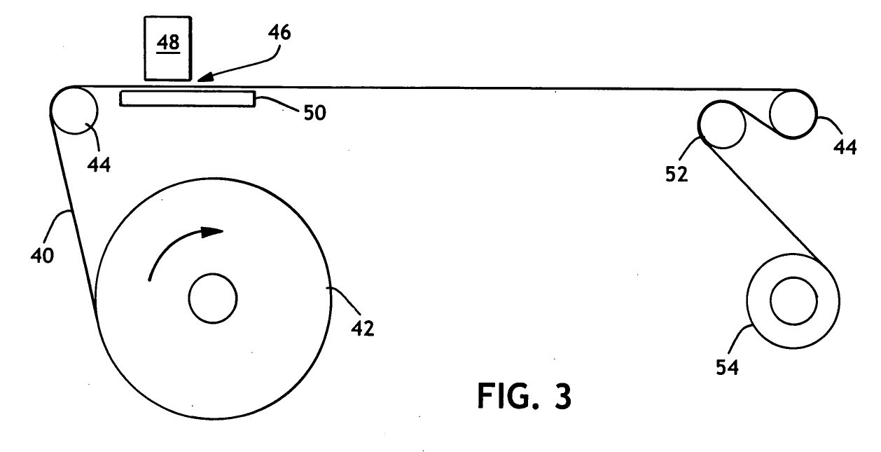

FIG. 3 shows schematically an exemplary second inline treatment step applied to web 40 having been previously treated as, for example, using the saturation spray device 12 of FIG. 1. In this embodiment, web 40 is unwound from roll 42 and directed around guide roll 44 through printing station 46 including ink jet printhead 48 and web support platen/exhaust hood 50. The web has applied to the surface facing the printhead a light application of the antistat. The web may then be directed by one or more drive rolls 52 and rewound into treated roll 54 or, optionally, otherwise processed.

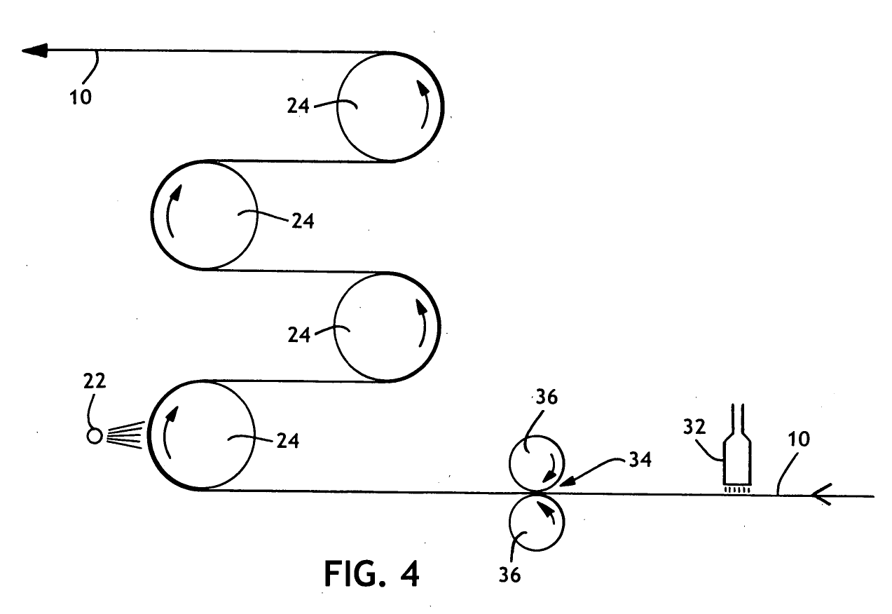

FIG. 4 shows a third embodiment where the foam applicator 32 is used to apply fluorocarbon to one side of web 10 and spray 22 to apply antistat to the opposite side at steam can 24. Otherwise the process is like the process schematically illustrated in FIG. 2.

### EXAMPLES

The present invention is further described by the examples which follow. Such examples, however, are not to be construed as limiting in any way either the spirit or the scope of the present invention.

For those examples using SMS fabric, the general process for forming the fabric and treating it was as follows:

A spunbond/meltblown/spunbond (SMS) laminate consisting of about 35 weight percent of a first spunbond layer, about 30 weight percent of meltblown layer and about 35 weight percent of a second spunbond layer was formed as described in U.S. Pat. No. 4,041,203 to Brock et al. After forming, the SMS laminate was thermally bonded with a bonding roll resulting in about 15 percent bond area in a wire weave pattern. The fabrics produced for the examples had a basis weight of about 1.5 oz/yd² (51 gsm) or a basis weight of about 1 oz/yd² (about 34 gsm) as specified. After bonding, the SMS laminate was treated off line on a pilot dip and squeeze treater at about 50 feet per minute and dried over steam cans at 245° F. as specified below. However, the SMS laminate can be treated in line, for example by passing the SMS laminate through a saturator containing a treatment bath as generally illustrated in FIG. 1 or by immersing the laminate in a bath containing the treatment solution. The amount of non-ionic fluoropolymer emulsion needed in the treatment composition is dependent upon the level of alcohol repellency desired and generally believed to be dependent of the specific non-ionic fluoropolymer chosen and the exposure time of the substrate to the treatment composition. In general, the less time that a laminate is exposed to a treatment composition, the greater the amount of non-ionic fluoropolymer emulsion is suggested in the bath to obtain the level of fluorine on the substrate to achieve a targeted level of repellency. Each of the examples was prepared in the same manner. Samples of dried, treated material of each example were tested for alcohol repellency, water barrier as measured by hydrostatic head and fluorine add-on level to determine the add-on efficiency of the method.

The treatment compositions varied as specified in the each of the following Examples. A fluorine-containing compound, for example a non-ionic fluoropolymer, was added to increase the isopropanol repellency of the finished, dried laminate. An alcohol, for example octanol, was added to aid in wetting out the laminate completely. As the water is dried off the laminate in a later step, the alcohol is volatilized. The amount of octanol used was typically 0.25 percent by weight in the aqueous treatment bath. For example in a commercial inline process, after saturation, which results in about 300 percent wet pickup based on fabric weight, the fabric can be run through a squeeze nip, resulting in a reduction in the wet pickup to about 100 percent and then over a dewatering vacuum apparatus, further reducing the wet pickup to about 40 percent. After drying using steam cans, the treated fabric can be wound on cardboard cores.

The amount of fluoropolymer emulsion included in the treatment composition can vary and is dependent on several factors including, but not limited to, the level of alcohol repellency desired and the time the substrate is exposed to the treatment solution. In general, the less time that the laminate is exposed to the fluoropolymer containing treatment the more fluoropolymer is needed to reach a targeted level of repellency. For the Daikin UNIDYNE® TG-KC02 non-ionic fluoropolymer suspension and the process conditions chosen in the Examples below, treatment compositions containing from about 0.1 to about 1 weight percent of the non-ionic fluoropolymer suspension were used. The amount of fluoropolymer is also believed to be dependent on the particular fluoropolymer that is selected.

The treatment solutions for each example were prepared as follows. The specified weight of fluoropolymer emulsion was added to water in a 1000 ml beaker. The non-ionic fluoropolymer emulsion was initially mixed into the water using a spatula and then placed under a Ross high shear mixer. Under vigorous mixing, the specified amount of other ingredients, if any, and the specified amount of octanol was added to the mixture and further mixed a high speed for an additional 2 minutes. The emulsion was then transferred to a pan large enough to accommodate an 8-inch by 10-inch sample of the SMS fabric. An 8-inch by 10-inch sample of the SMS fabric was then completely submerged in the emulsion and flipped over and submerged in the emulsion again to ensure complete wet out. The saturated SMS fabric was then run through an Atlas laboratory ringer equipped with 100 lbs equivalent weights to reduce the wet pick up (WPU). The resulting emulsion was then fed into a saturation pan and continuously added to maintain the required amount of fluid necessary to saturate the SMS web passing through the equipment. The resulting wet pick up (WPU) of the formulation on the SMS was 300 percent by weight of the SMS. The WPU can be calculated as WPU=100 %×(wet weight-dry weight)/dry weight. The SMS web then passed through a wringer capable of reducing the wet pick up from 300 percent down to 100 percent. The liquid that was removed from the sheet was allowed to recirculate back into the saturation pan. Finally, the treated SMS web passed through a large forced hot air drying unit capable of reducing the WPU from 100 percent to bone dry (0 percent WPU).

The percent fluorine add-on level on the samples was determined by an independent laboratory (Galbraith Laboratories of Knoxville, Tenn.) using an elemental analysis technique. The hydrostatic head of the samples was measured according to Federal Test Standard 191A, Method 5514. The alcohol repellency of the samples was measured by placing 0.1 ml of a specified percentage of isopropyl alcohol aqueous solution in several different locations on the surface of the fabric and leaving the specimen undisturbed for 5 minutes. The grading scale ranges from 0 to 5, with 0 indicating the IPA solution wets the fabric and 5 indicating maximum repellency. Unless stated otherwise, the percent alcohol (IPA) repellency reported indicates the maximum volume percent of IPA that could be added to water while still retaining a 5 rating on the scale at all points of the fabric tested. This procedure is a modification of INDA Standard Test No. IST 80.9-74 (R-82).

### Comparative Example A

Comparative Example A consisted of untreated 1.5 osy SMS laminate fabric. The alcohol repellency of Comparative Example A was measured at 20 percent IPA. The water barrier property of Comparative Example A was measured at a hydrostatic head of 84.9±6.2 mBar. The untreated 1.5 osy SMS fabric provides desirable water barrier but does not provide acceptable alcohol repellency.

### Comparative Example B

Comparative Example B consisted of untreated 1.5 osy SMS laminate fabric that was treated in a bath that included an ionic fluoropolymer and an anionic antistatic agent. The aqueous treatment bath for Comparative Example B consisted of water in which was dissolved, or at least suspended, 0.69 weight percent of a cationic fluoropolymer suspension from Daikin America, Inc. identified as UNIDYNE® TG-KC01 and 0.30 weight percent of QUADRASTAT PIBK anionic antistatic agent obtained from Manufacturers Chemical of Cleveland, Tenn. The alcohol repellency of Comparative Example B was measured at 90 percent IPA. The water barrier property of Comparative Example B was measured at a hydrostatic head of 46.3±3.1 mBar. And, the fluorine add-on level of Comparative Example B was measured at 0.36 weight percent.

### Example 1

Example 1 is an example of a dip saturation treatment method of treating a 1.5 osy SMS nonwoven surgical fabric with an aqueous treatment solution that includes a nonionic fluoropolymer and a polymeric antistatic agent. The treatment bath suspension of Example 1 consisted of a water bath in which was dissolved, or at least suspended, 0.50 weight percent of non-ionic fluoropolymer suspension UNIDYNE® TG-KC02 obtained from Daikin America, Inc. of Orangeberg, N.Y. and 0.20 weight percent of NICEPOLE® FL polymeric antistatic agent obtained from NICCA U.S.A. Inc., of Fountain Inn, S.C. The UNIDYNE® TG-KC02 non-ionic fluoropolymer suspension obtained from Daikin contained about 30 weight percent of non-ionic fluoropolymer solids and the wet pick-up rate of the treatment solution on the SMS fabric for Example C was about 116 weight percent. NICEPOLE® FL polymeric antistatic agent is a cationic polymeric antistatic agent that is soluble in cold water and has a pH of about 7.7 to about 8.5 in a 1 percent solution of water.

The UNIDYNE® TG-KC02 non-ionic fluoropolymer suspension obtained from Daikin contained about 30 weight percent of non-ionic fluoropolymer solids and the wet pick-up rate of the treatment solution on the SMS fabric for Example 1 was about 100 weight percent. The non-ionic fluoropolymer treated SMS surgical fabric was dried for 2 minutes at about 245° F. The alcohol repellency of the dried, non-ionic fluoropolymer treated Example 1 was measured at 80 percent IPA.

### Example 2

Example 2 is another example of a dip saturation treatment method of treating a 1.5 osy SMS nonwoven surgical fabric with an aqueous treatment solution that includes both a nonionic fluoropolymer and a polymeric antistatic agent in a single treatment solution. The treatment bath suspension of Example 2 consisted of a water bath in which was dissolved, or at least suspended, 0.57 weight percent of non-ionic fluoropolymer suspension UNIDYNE® TG-KC02 and 0.50 weight percent of NICEPOLE® FL polymeric antistatic agent.

The UNIDYNE® TG-KC02 non-ionic fluoropolymer suspension contained about 30 weight percent of non-ionic fluoropolymer solids and the wet pick-up rate of the treatment solution on the SMS fabric for Example 2 was about 100 weight percent. The non-ionic fluoropolymer treated SMS surgical fabric was dried for 2 minutes at about 245° F. The alcohol repellency of the dried, non-ionic fluoropolymer treated Example 2 was measured at 80 percent IPA.

A summary of the experimental data is present in Table 1 below.

TABLE 1

| | | Isopropyl Alcohol | Hydrostatic | 50% Static Decay, |
|---|---|---|---|---|
| | Treatment Solution | Repellency | Head, 3^{rd} Drop | 50% RH |
| Example | Composition | (v:v % pass) | (mBar) | (+ seconds) |
| Control A | untreated 1.5 osy SMS | 20 | 84.9 ± 6.2 | N/A |
| Control B | 1.5 osy SMS treated with | 90 | 46.3 ± 3.1 | 0.07 |
| | 0.69 w/% TG-KC01 and | | | |
| | 0.30 w/% QUADRASTAT PIBK | | | |
| EXAMPLE 1 | 1.5 osy SMS treated with | 80 | 80.5 ± 6.6 | 0.04 |
| | 0.50 w/% TG-KC02 | | | |
| | 0.20 w/% NICEPOLE FL | | | |
| EXAMPLE 2 | 1.5 osy SMS treated with | 80 | 79.0 ± 11.1 | 0.02 |
| | 0.50 w/% TG-KC02 | | | |
| | 0.40 w/% NICEPOLE FL | | | |

Treating the 1.5 osy SMS laminate fabric with fluoropolymer, both TG-KC01 and TG-KC02, improved the alcohol repellency of the fabric (Examples B, 1 and 2 versus untreated Example A). However, treatment of the SMS fabric with fluoropolymer and an alkyl phosphate ester antistatic agent (Example B) decreased the water barrier properties of the fabric (Example B versus untreated Example A). Examples 1 and 2 show that treatment with both fluoropolymer UNIDYNE® TG-KC02 and polymeric antistatic agent NICEPOLE® FL exhibit improved repellency to low surface tension fluids, static charge dissipation and liquid barrier properties as measured by alcohol repellency, hydrostatic head and antistatic properties. Increasing the treatment concentration of the antistatic agent, for example doubling the concentration of the NICEPOLE® FL antistatic agent in the treatment composition as done in Example 2, to increase static decay properties did not negatively effect the hydrohead and alcohol repellency properties of the treated fabric (compare Example 2 versus Example 1).

Although various embodiments of the invention have been described above using specific terms, devices, and methods, such description is for illustrative purposes only. The words used are words of description rather than of limitation. It is to be understood that changes and variations may be made by those of ordinary skill in the art without departing from the spirit or scope of the present invention, which is set forth in the following claims. In addition, it should be understood that aspects of the various embodiments may be interchanged both in whole or in part. Therefore, the spirit and scope of the appended claims should not be limited to the description of the preferred versions contained therein.

We claim:

1. A method of treating a nonwoven fabric to improve the alcohol repellency and antistatic properties of the nonwoven fabric while minimizing effect of the treatment on the water repellency of the nonwoven fabric, the method comprising contacting a nonwoven fabric comprising polyolefin fibers with an aqueous treatment solution that comprises from about 0.1 weight percent to about 5 weight percent of a fluoropolymer and from about 0.01 to about 5 weight percent of a polymeric antistatic agent.

2. The method of claim 1, wherein the polymeric antistatic agent is a cationic polymeric compound.

3. The method of claim 2, wherein the cationic polymeric antistatic agent is an acrylic copolymer.

4. The method of claim 1, wherein the fluoropolymer is a non-ionic fluoropolymer.

5. The method of claim 1, wherein the nonwoven fabric is selected from the group consisting of spunbond fabrics, meltblown fabrics and laminates thereof.

6. The method of claim 1, wherein the polymeric antistatic agent is selected from the group consisting of cationic polymeric compounds, acrylic copolymers and cationic acrylic copolymers.

7. The method of claim 1, wherein the hydrostatic head value of the treated nonwoven fabric has a hydrostatic head value of no more than about 10 percent less than the hydrostatic head value of a comparable, untreated nonwoven fabric.

8. The method of claim 1, wherein the treated nonwoven fabric has a hydrostatic head value of greater than 35 mBar as measured by Federal Test Standard 191A, Method 5514.

9. The method of claim 1, wherein the treated nonwoven fabric has an alcohol repellency of at least 60 percent as measured by INDA Standard Test No. IST 80.9-74 (R-82) and a hydrostatic head value of greater than 75 mBar as measured by Federal Test Standard 191A, Method 5514 and the method of treating the nonwoven fabric decreases the hydrostatic head value of the nonwoven fabric by less than 10 percent.

10. The method of claim 1, wherein the treated nonwoven fabric has an alcohol repellency of at least 75 percent as measured by INDA Standard Test No. IST 80.9-74 (R-82) and a hydrostatic head value of greater than 70 mBar as measured by Federal Test Standard 191A, Method 5514.

11. The method of claim 1, wherein the polymeric antistatic agent is a cationic polymeric compound that is soluble in water and forms a solution having a pH of greater than about 7.5.

12. The method of claim 1, wherein the nonwoven fabric is an infection control fabric that is or comprises a spunbond/meltblown/spunbond laminate, a spunbond/film/spunbond laminate, a spunbond/film/spunbond/meltblown/spunbond laminate or a spunbond/film/film/spunbond laminate.

13. The method of claim 2, wherein non-ionic fluoropolymer is selected from the group consisting of fluoroalkyl acrylate homopolymers, fluoroalkyl acrylate copolymers, fluorinated siloxanes, fluorinated silicones, fluorinated urethanes, and mixtures thereof.

14. The method of claim 2, wherein non-ionic fluoropolymer is a non-ionic fluoroalkyl acrylate copolymer.

15. A nonwoven fabric treated according to the method of claim 1.

16. A nonwoven fabric having antistatic and alcohol repellent properties comprising a fluoropolymer and a polymeric antistatic agent.

17. The nonwoven fabric of claim 16 wherein the nonwoven fabric is a laminate or a portion of a laminate.

18. An infection control product comprising a nonwoven fabric laminate of claim 16.

19. A method of improving the alcohol repellency of a nonwoven laminate by applying a topical treatment to a nonwoven laminate while minimizing any negative effect of the topical treatment on the water repellency of the nonwoven laminate, the method comprising: providing a nonwoven laminate;
contacting an aqueous treatment solution that includes from about 0.20 weight percent to about 5 weight percent of a mixture of a fluoropolymer and a polymeric antistatic agent with the nonwoven laminate or a portion of the nonwoven laminate;
wherein the fluoropolymer is selected from the group consisting of non-ionic fluoroalkyl acrylate homopolymers, fluoroalkyl acrylate copolymers, fluorinated siloxanes, fluorinated silicones, fluorinated urethanes, and mixtures thereof.

20. A nonwoven laminate treated according to the method of claim 19.
